(19) United States
(12) Patent Application Publication
(10) Pub. No.: US 2006/0267394 A1
(43) Pub. Date: Nov. 30, 2006

(54) Improvement of child safety seat set-up in a vehicle

(76) Inventors: Yair David, Ramat Hasharon (IL); Arnon David, Modi'in (IL)

Correspondence Address: YAIR DAVID, ANKOR 6, RAMAT HASHARON, 47229, IL

(21) Appl. No.: 11/162,827

(22) Filed: Sep. 24, 2005

Related U.S. Application Data
(63) Continuation of application No. 60/685,398, filed on May 31, 2005.

(51) Int. Cl. B60R 22/00

(52) U.S. Cl. 297/468

(57) ABSTRACT

A seatbelt adaptor and a method to be used to improve of the setup of a child safety seat in a vehicle, the seatbelt adaptor comprising a central lengthening device and two connectors disposed at both ends of the central lengthening device. The connectors are suited for the buckles of the vehicle's seatbelts, and wherein the length of the seatbelt adaptor is suited to improve upon the latching of the buckle of the seatbelt that secures a child seated in a safety seat within a vehicle.

### REFERENCE TO CROSS-RELATED APPLICATION

This application claims priority to Provisional Application No. 60/685,398, filed on May 31, 2005, herein incorporated by reference in its entirety.

### FIELD AND BACKGROUND OF THE INVENTION

The present invention relates to a device, an article of manufacture, and a method for setting up a child safety seat in a vehicle and, in particular to a device, an article of manufacture, and a method, enabling a quick and efficient way to fasten and release the belt buckles which fix the child safety seat or child sitting in the child booster safety seat to the seat's location on the vehicle seat.

Buckling a child to a vehicle seat with the vehicle's seatbelts does not provide sufficient protection in case of an emergency braking or in an accident, for reasons such as the following:

The seat belts are not sufficiently sung on a small body and do not comprise a sufficient downward force.

The shoulder belt could lacerate the child's neck.

Most children are not mature enough to be seated in a seat designated for adults.

Children cannot bend their knees at the end of the seat when their backs are against the backrest of the seat.

In order to overcome these difficulties, the booster seat, which is a seat that raises the child and provides a higher sitting height so the adult lap and shoulder belts fit better, has been available for approximately thirty years.

The standard recommendation is to use booster seats for children of ages 4 to 8, weighing 20 to 40 kg.

An example of the existing standard setting is shown in FIGS. 1a and 1b.

FIG. 1a depicts a child safety seat, of booster type 13, on a vehicle's back seat 11 near the backrest 12 of the back seat. On one side of the safety seat 13 the vehicle's seatbelt 14 is disposed with a latch plate 15 attached to it and on the other side, a buckle 16. Usually the buckle 16 is disposed in the back seat 11 for the comfort of adult passengers.

FIG. 1b depicts the instance in which a child 17 is properly seated with the seatbelt 14 latched by connecting the latch plate 15 into the buckle 16. This configuration makes the access of the buckles by two adult hands in order to latch them extremely difficult. The latching action becomes even harder when an additional safety seat or extra luggage such as a bag or suitcase is placed besides the buckle 16.

When a child is fastened in a safety seat, the possibility to quickly and easily unfasten the seatbelt's buckles is of utmost importance, especially when the child needs to be removed from the vehicle as quickly as possible. The duration of the belt buckles' release action in the existing situation may be critical in an emergency because of the limited access to the belt buckles.

There is therefore a need to improve the setup of a child safety seat in a vehicle and to ensure the possibility of speedy release of the seatbelts strapping the child into the safety seat.

### SUMMARY OF THE INVENTION

It is an objective of the present invention to provide a device, an article of manufacture, and a method to improve the setup of a child safety seat in a vehicle.

According to the present invention there is provided a seatbelt adaptor to be used to improve of a child safety seat setting up in a vehicle including: (a) a central lengthening device selected from a group consisting of a safety belt, a rigid device, and an elastic device; (b) a first connector disposed at one end of the central lengthening device; and (c) a second connector disposed at the second end of the central lengthening device; wherein the first connector and the second connector are suited for the buckles of a vehicle's seatbelt, and wherein the length of the seatbelt adaptor is suited to improve the latching of the buckles of the seatbelt that secures a child into a safety seat within a vehicle.

According to further features in preferred embodiments of the invention the seatbelt adaptor is suited to improve the latching of a vehicle's seatbelt, where the vehicle's seatbelt secures the child seated in the safety seat.

According to further features in preferred embodiments of the invention the seatbelt adaptor is suited to improve upon the latching of a vehicle's seatbelt, where the vehicle's seatbelt secures the safety seat to the vehicle's seat.

According to further features in preferred embodiments of the invention the first connector is a latch plate and wherein the second connector is a buckle.

According to further features in preferred embodiments of the invention the central lengthening device is a safety belt with adjustable length.

According to further features in preferred embodiments of the invention, the seatbelt adaptor further includes: (d) a device that prevents a child from releasing the buckle, wherein the device that prevents a child from releasing the buckle is disposed in the seatbelt adaptor.

According to the present invention there is provided a method for enabling a user to improve the setup of a child safety seat in a vehicle, the method including the steps of: (a) providing the user with seatbelt adaptor, the seatbelt adaptor including: (i) a central lengthening device selected from a group consisting of a safety belt, a rigid device, and an elastic device; (ii) a first connector disposed at one end of the central lengthening device; and (iii) a second connector disposed at the other end of the central lengthening device; wherein the first connector and the second connector are suited for the buckles of the vehicle's seatbelt, and wherein the length of the seatbelt adaptor is suited to improve the latching of the buckle of the vehicle's seatbelt that secures a child seated in a safety seat within a vehicle on a vehicle's seat; (b) connecting the first connector to the vehicle's buckle located near the vehicle's seat; (c) seating a child in the safety seat; (d) connecting the second connector to the buckle of the vehicle's seatbelt, wherein the buckle of the vehicle's seatbelt can be a latch plate; wherein when the vehicle's seatbelt is to be fastened on the child's body.

According to further features in preferred embodiments of the invention the first adaptor is a latch plate and wherein the second adaptor is a buckle.

According to further features in preferred embodiments of the invention the central lengthening device is a safety belt with adjustable length.

According to further features in preferred embodiments of the invention the method further including: the step of: (d) releasing the second adaptor.

According to the present invention there is provided an article of manufacture for use as a child restraint system used in a motor vehicle, wherein a vehicle safety seatbelt is used as the child's safety seatbelt and wherein a vehicle safety seatbelt's latch plate can be comfortably connected and released, enabling safe restraining of the child in normal operation and in case of emergency and enabling easy and safe release of the child from the restraint system, the article of manufacture including: (a) a booster safety seat; and (b) a seatbelt adaptor, the seatbelt adaptor being positioned adjacent to the booster safety seat; wherein the seatbelt adaptor can be connected between a vehicle safety seatbelt's latch plate and an anchoring means in the vehicle, wherein the location of the connection of the vehicle safety seatbelt's latch plate to the seatbelt adaptor, while a child is buckled in the booster safety seat, is a practically optimal location enabling fast and easy release of the child from the restraint system, wherein the geometric characters combination of the booster safety seat and the seatbelt adaptor ensure that in case of emergency braking, the vehicle safety seatbelt will activate adducting forces on the child on the necessary directions required for the child's safety.

According to further features in preferred embodiments of the invention the anchoring means is disposed in the vehicle's structure.

According to further features in preferred embodiments of the invention the anchoring means is a vehicle's seatbelt buckle, enabling an adult to be buckled up with the safety seatbelt in a vehicle seat while the vehicle safety seatbelt buckle is located in close proximity to the vehicle seat and to the vehicle seat's backrest.

According to further features in preferred embodiments of the invention the seatbelt adaptor further including: (a) a central lengthening device selected from a group consisting of a safety belt, a rigid device, and an elastic device; (b) a first connector disposed at one end of the central lengthening device; and (c) a second connector disposed at the second end of the central lengthening device; wherein the first connector and the second connector are suited for the buckles of the vehicle's seatbelt.

According to further features in preferred embodiments of the invention the first connector is a latch plate and wherein the second connector is a buckle.

According to further features in preferred embodiments of the invention the central lengthening device is a safety belt of a fixed length.

According to further features in preferred embodiments of the invention the central lengthening device is a safety belt of adjustable length.

According to further features in preferred embodiments of the invention, the seatbelt adaptor further includes: (iv) a device that prevents children from unfastening the buckle; wherein the device that prevents children from unfastening the buckle disposed in the seatbelt adaptor.

According to further features in preferred embodiments of the invention the article of manufacture further including: (c) a seat cushion disposed at the booster safety seat; wherein the combination of the geometrical qualities of the booster safety seat, the seatbelt adaptor, and the seat cushion, ensures that in the case of emergency braking the vehicle's seatbelt will exert adducting forces on the child towards the seat in the necessary directions for the child's safety.

### BRIEF DESCRIPTION OF THE DRAWINGS

The invention is herein described, by way of example only, with reference to the accompanying drawings, wherein:

FIG. 1a of the prior art illustrates an empty safety seat placed in the back seat of a medium sized passenger vehicle.

FIG. 1b of the prior art illustrates a child seated in a safety seat, with the seatbelts fastened. The safety seat is installed in the back seat of a medium sized passenger vehicle.

FIG. 2a is a schematic illustration of a preferred embodiment of a seatbelt adaptor with a strap of a fixed length.

FIG. 2b is a schematic illustration of a preferred embodiment of a seatbelt adaptor with a strap of adjustable length.

FIG. 2c is a schematic illustration of a preferred embodiment of a seatbelt adaptor made as a rigid unit.

FIG. 2d is a schematic illustration of a preferred embodiment of a seatbelt adaptor made as an elastic unit.

FIG. 2e is a schematic illustration of a preferred embodiment of a seatbelt adaptor with an apparatus preventing the buckle release by a child.

FIG. 2f is a schematic illustration of a preferred embodiment of a seatbelt adaptor attached to the vehicle's seatbelts.

FIG. 3a depicts a front view of a child seated in a booster safety seat, with the seatbelts fastened according to a preferred embodiment of the present invention.

FIG. 3b is a schematic illustration of a preferred embodiment of the present invention depicting a front view of the necessary direction of the vertical force exerted by the seat belt during an emergency braking on a child seated in the booster safety seat as depicted in FIG. 3a.

FIG. 3c is a schematic illustration of a preferred embodiment of the present invention depicting a detailed magnification of a part of FIG. 3b.

FIG. 3d is a schematic illustration of a preferred embodiment of the present invention depicting a side view of the necessary directions of horizontal and vertical forces exerted by the seatbelt during emergency braking on the child seated in a booster safety seat.

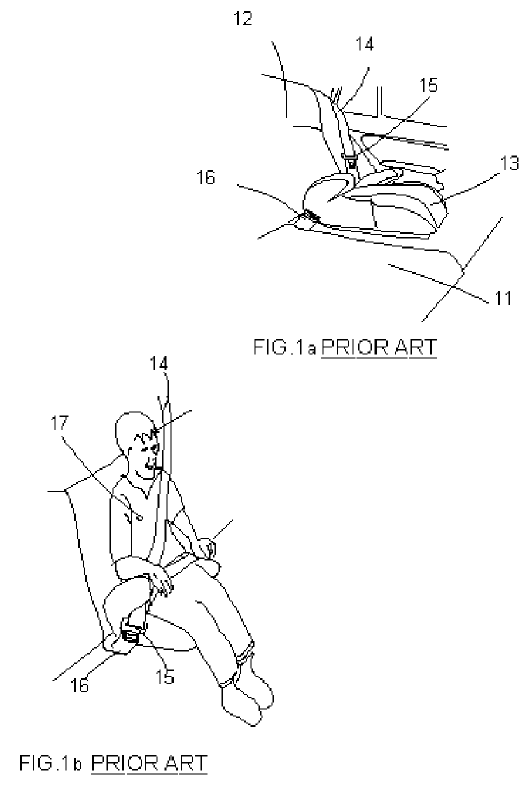

### DESCRIPTION OF THE PREFERRED EMBODIMENTS

The present invention is a seatbelt adaptor, an article of manufacture and a method to improve the setup of a child safety seat in a vehicle.

The principles and operation of the seatbelt adaptor, and the article of manufacture according to the present invention may be better understood with reference to the drawings and the accompanying description.

Before explaining at least one embodiment of the invention in detail, it is to be understood that the invention is not limited in its application to the details of construction and the arrangement of the components set forth in the following description or illustrated in the drawings.

Unless otherwise defined, all technical and scientific terms used herein have the same meaning as commonly understood by one of ordinary skill in the art to which this invention belongs. The materials, methods, and examples provided herein are illustrative only and not intended to be limiting.

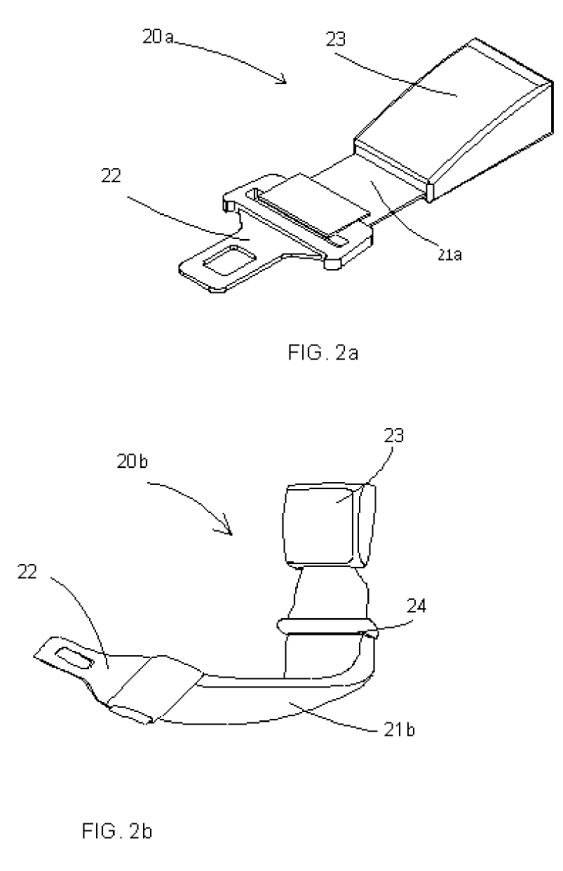

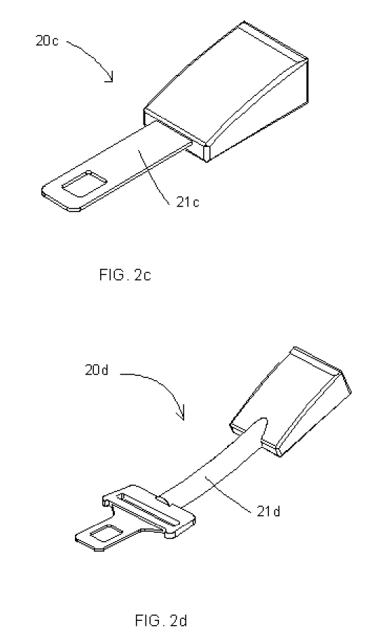

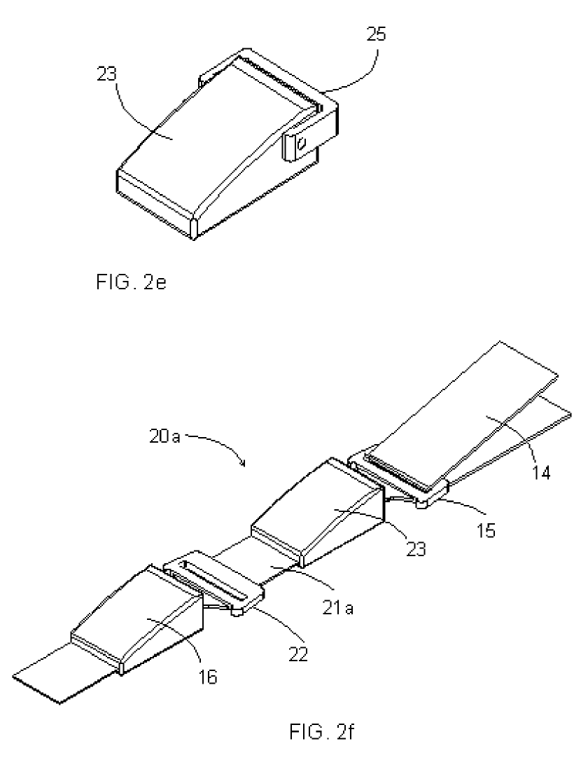

Referring now to the drawings, FIG. 2a is a schematic illustration of a preferred embodiment of a seatbelt adaptor 20a with a safety belt of a fixed length 21a. The safety belt 21a lacks any practical resistance to flexion loads and can be identical or similar to the existing seatbelts already installed in the vehicle in which it will be installed as a matter of the material of which it is made and its dimensions, except for its length, which is fitted for its unique purpose. A latch plate 22 is disposed at one end of the safety belt 21a and a buckle 23 is disposed at the other end of the safety belt 21a. Latch plate 22 and buckle 23 are connectors which are compatible with the vehicle's seatbelt buckles and latches. Safety belt 21a constitutes a central lengthening device, which mechanically connects latch plate 22 and buckle 23, and determines the distance between them.

This invention is not limited to the use of a specific safety belt and the latch plate 22 and the buckle 23 may be connected by many means, such as one or more chains, one or more strings, or as depicted later in FIGS. 2b-2d.

This invention is not limited to the type of buckles which enable the connection of the seatbelt adaptor, to the vehicle's seatbelt and vehicle's seatbelt buckles.

The invention also includes the possibility of connecting the seatbelt adaptor directly to the anchoring point of the vehicle's safety belts.

FIG. 2b is a schematic illustration of a preferred embodiment of a seatbelt adaptor 20b with a belt of adjustable length. The difference in comparison with seatbelt adaptor 20a is that in seatbelt adaptor 20b has a belt of adjustable length 21 b. There are many ways to construct a belt of adjustable length, which anyone skilled in the art is familiar with. The current figure schematically illustrates a ring 24 to which the end of the adjustable length belt 21b is connected through latch plate 22.

FIG. 2c is a schematic illustration of a preferred embodiment of a seatbelt adaptor 20c made as a rigid device, whose structure, and in particular whose central lengthening device 21c is practically non-bendable by reasonable bending moments which may be induced on it.

FIG. 2d is a schematic illustration of a preferred embodiment of a seatbelt adaptor 20d made as an elastic device. Its structure and properties are similar to those of seatbelt adaptor 20c except for its central lengthening device 21d, which has elastic properties regarding the reasonable bending moments that may be induced on it.

FIG. 2e is a schematic illustration of buckle 23 equipped with a device 25 which prevents the buckle's release by a child.

FIG. 2f is a schematic illustration of seatbelt adaptor 20a connected to the vehicle's seatbelts. Latch plate 22 is connected to the buckle 16 and buckle 23 is connected to the latch plate 15 through which the vehicle's seatbelt 14 passes. The vehicle's seatbelt 14 is originally designed to be used on an adult's waist and diagonally from one hip towards the opposite shoulder.

Booster seats are in use because vehicle's seatbelts are not designed for children. Young children are too small for vehicle's seatbelts and too large for infant safety seats.

Millions of parents and caregivers use booster seats as protection for their children who have outgrown their infant safety seats but aren't tall enough for vehicle's seatbelts.

The location in which latch plate 15, through which the vehicle's seatbelt 14 passes, is connected to the vehicle's original buckle 16, and the location according to the present invention of the connection between the latch plate 15, through which the vehicle's seatbelt 14 passes, and the buckle of the seatbelt adaptor with regard to the booster safety seat and the child seated upon it, are of utmost importance.

The requirements that the components of a safety system comprised of a child safety seat, a vehicle's seatbelt, a latch plate, and a buckle, must meet include the following:

Any contact between a component of the system and the child that could harm the child as a result of friction, injury, or any other cause, when in use under normal travel conditions, when buckling and releasing, and in the case of emergency braking or an accident, is prohibited.

When a vehicle slows down abruptly, for example during emergency braking or a collision, the vehicle's seatbelt segment that is in the child's lap must fasten the child to the seat, with combined force exerted downwards and backwards with regard to the vehicle's axes, namely force must be exerted towards the vehicle's seat and towards the backrest of the seat, upon which the seat is placed.

The vehicle's seatbelt must be able to be quickly and easily released in case of an emergency.

The location of the original buckle in vehicle's seats is based on consideration of the forces exerted downwards and backwards on an adult seated in the seat, in case of need, and therefore the buckle is positioned low and close to the seat and its backrest. As a result, in many cases the requirement of fast release of the buckle, when used in conjunction with a booster child safety seat, is impaired, particularly when an additional child safety seat or other baggage item is also placed on the vehicle seat.

This problem has been known of for years, however no satisfactory solution has been found for it so far. Some parents have just given up on the possibility of connecting the vehicle's seatbelt and reasonably every time they seat their children in a safety seat, and have turned to the highly hazardous practice of fastening the buckles only once and seating and removing their children without unfastening the buckles.

The use of an existent lengthening strap for facilitating fastening and unfastening of the buckles is also hazardous. Many vehicle manufacturers have lengthening straps designed for larger passengers to buckle up in their vehicles. An example of this is Ford's seatbelt extender, which is a piece of seat belt material about 8 inches long with buckles on the ends of it that clicks into the existing seat belt's buckles. Use of a seatbelt lengthening such as this is hazardous as it does not meet the requirement of adducting forces in the right directions.

According to the present invention, the booster safety seat is used in conjunction with a seatbelt adaptor, whose qualities, and particularly whose length, are adapted to meet the safety requirements and also ensure that the location of the connection point of the latch plate 15 through which the vehicle's seatbelt 14 passes will be optimally practical. The optimal location is determined by the length of the seatbelt adaptor, which serves as a compromise between the minimal length which has an advantage with regard to the aforementioned force directions, and the maximal length which has an advantage with regard to the aforementioned convenience of unfastening. The boundaries of this field are from the shortest possible length defined by the size limitations of the components to the longest possible length that in case of emergency braking with exertion of force on the diagonal segment of the vehicle's seatbelt, the tension that is generated due to the high location of latch plate 15 does not generate a downwards adducting force in the vehicle's seatbelt segment resting in the child's lap.

The seatbelt adaptor can be connected to the buckle 16 and can be removed when an adult is seated and buckled up in the seat, or can be connected directly to an anchoring point in the vehicle.

In the case that the seatbelt adaptor is connected to an anchoring point within the vehicle, it can be of a fixed length that is a compromise between buckling up an adult and bucking up a child in a safety seat.

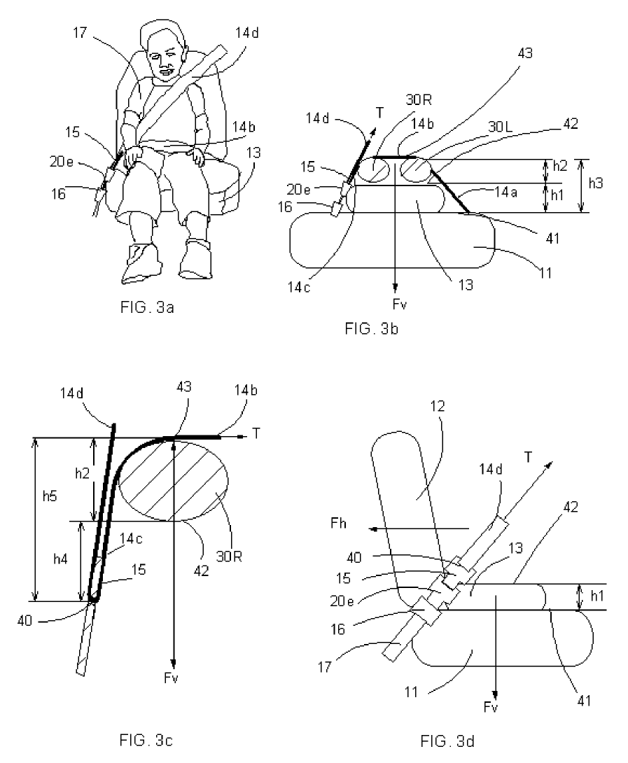

FIG. 3a illustrates the front view of a child seated in a booster safety seat 13, with the vehicle's seatbelt fastened according to a preferred embodiment of the present invention. The child 17 is seated in the booster safety seat 13 and is buckled in a vehicle's seatbelt whose upper segment 14d crosses the child's chest diagonally, from one shoulder to the waist on the opposite side, through latch plate 15 and over the child's lap as a segment 14b of the vehicle's seatbelt. The latch plate 15 connects to seatbelt adaptor 20e which is connected to the buckle 16.

FIG. 3b is a schematic illustration of a preferred embodiment of the present invention depicting a front view of the required direction of the vertical force Fv exerted by the seatbelt on the child seated in the booster safety seat 13, as described in FIG. 3a. The booster safety seat 13, which is placed upon the vehicle seat 11, seats a child whose right leg 30R and left leg 30L are shown in the illustration in section. This illustration shows the vehicle's seatbelt in further detail, with its diagonal segment 14d reaching latch plate 15, inside which it bends back over approximately 180 degrees and returns with the belt segment 14c until bending over the child's right leg 30R, continuing as an approximately horizontal segment until bending back diagonally downwards over the child's left leg 30L as vehicle's seatbelt segment 14a. Latch plate 15 connects to seatbelt adaptor 20e, which is connected to buckle 16. In case of emergency braking, tension T is generated in the vehicle's seatbelt, exerting adducting force Fv downwards relative to the vehicle and adducting the child's lap area downwards to the safety seat. The illustration shows three surfaces, surface 41, which is the upper surface of the vehicle seat 11 upon which the safety seat 13 is placed, surface 42, which is the upper surface of the booster safety seat 13 upon which the child is seated, which can also be the upholstery of said booster safety seat 13 or a cushion, and virtual surface 43 at level with the child's legs 30L and 30R, defining the boundaries for seatbelt segment 14b.

The illustration also shows the gaps between these surfaces, with hi being the vertical gap between surface 41 and surface 42, h2 being the vertical gap between surface 42 and surface 43 and h3 being the vertical gap between surface 41 and surface 43.

FIG. 3c is a schematic illustration of a preferred embodiment of the present invention enlarging a part of FIG. 3b.

Point 40 is the point at which the total equivalent force is exerted by the vehicle's seatbelt 14 on latch plate 15.

This illustration shows a section of latch plate 15 with both vehicle seatbelt segments 14c and 14d changing direction at approximately 180 degrees at an axis including point 40. For the tension force T in the vehicle's seatbelt to generate a downwards adducting force Fv in case of need, point 40 must be sufficiently low with regard to the safety seat and the child's leg 30R, otherwise the tension force T will create a distance between the seatbelt segment 14b and the child's legs and enable the child to be separated from the seat, causing severe harm to the child in case of emergency braking and an accident. The illustration also shows the vertical gap h4 between point 40 and surface 42 and vertical gap h5 between point 40 and surface 43.

FIG. 3d is a schematic illustration of a preferred embodiment of the present invention showing a side view of the required directions of the vertical and horizontal forces that are exerted by the seatbelt on the child seated in the booster safety seat 13 during an emergency braking. Proper location of point 40, which was explained in the description of FIG. 3c, will ensure the generation of a force with adducting components, downwards component Fv on the vertical plane and backwards component Fh on the horizontal plane with regard to the vehicle's axes, when tension force T is exerted. Proper location of point 40 ensures that gaps h4 and h5 are large enough when point 40 is on a lower plane than that of surface 43 or even on a lower plane than that of surface 42 so that downwards adducting force component Fv is exerted in the case of need. Gap h4 also depends on the geometric qualities of the booster safety seat 13 and of seatbelt adaptor 20e.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

1. A seatbelt adaptor to be used to improve the setup of a child booster safety seat in a vehicle, for use in conjunction with a conventional seatbelt restraint system, the seatbelt adaptor comprising:
(a) a central lengthening device wherein said lengthening device is a rigid device;
(b) latch plate for reversible attachment and detachment to a buckle of said conventional seatbelt restraint system, said latch plate disposed at a first end of said central lengthening device; and
(c) a buckle for reversible attachment and detachment to a latch plate of said conventional seatbelt restraint system, said buckle disposed at a second end of said central lengthening device,
wherein said latch plate of said seatbelt adaptor is configured for reversibly connecting to said buckle of said conventional seatbelt restraint system, and wherein said buckle of said seatbelt adaptor is configured for reversibly connecting to said latch plate of said conventional seatbelt restraint system, that secures a child into said child booster safety seat within said vehicle, and wherein the length of said seatbelt adaptor is suited to improve the latching of the buckles of said vehicle's conventional seatbelt restraint system, wherein said buckle of said seatbelt adaptor has a conventional seatbelt restraint system buckle structure, that enables the detachment of said buckle of said seatbelt adaptor from said latch plate of said conventional seatbelt restraint system, by the single press of a finger, and wherein said buckle of said seatbelt adaptor includes no permanent bolt coupling.

2. (canceled)

3. (canceled)

4. (canceled)

5. The seatbelt adaptor of claim 4, wherein said central lengthening device is a safety belt with adjustable length.

6. The seatbelt adaptor of claim 4, wherein said seatbelt adaptor further comprises:
(d) a device that prevents a child from releasing said buckle;
Wherein said device that prevents a child from releasing buckle disposed in said seatbelt adaptor.

7. A method for enabling a user to improve the setup of a child safety seat in a vehicle, the method comprising the steps of:
(a) providing the user with seatbelt adaptor, said seatbelt adaptor including:
(i) a central lengthening device selected from a group consisting of a safety belt, a rigid device, and an elastic device;
(ii) a first connector disposed at one end of said central lengthening device; and
(iii) a second connector disposed at the other end of said central lengthening device;
Wherein said first connector and said second connector are suited for the buckles of the vehicle's seatbelt that secures a child into a safety seat within a vehicle on a vehicle's seat, and wherein the length of said seatbelt adaptor is suited to improve the latching of the buckles of said vehicle's seatbelt;
(b) connecting said first connector to a vehicle's buckle located near said vehicle's seat;
(c) seating a child in said safety seat;
(d) connecting said second connector to said buckle of said vehicle's seatbelt;
Wherein said vehicle's seatbelt is to be fastened on the child's body.

8. The method of claim 7, wherein said first connector is a latch plate and wherein said second connector is a buckle.

9. The method of claim 7, wherein said central lengthening device is a safety belt with adjustable length.

10. The method of claim 7, further comprising the step of:
(d) releasing said second connector.

11. An article of manufacture for use as a child restraint system used in a motor vehicle, wherein the motor vehicle has a conventional seatbelt restraint system for use of an adult, wherein the conventional seatbelt restraint system has a safety seatbelt, a latch plate and a buckle, wherein the latch plate of the conventional seatbelt restraint system has a slot through which the safety seatbelt of the conventional seatbelt restraint system passes, and wherein the latch plate of the conventional seatbelt restraint system operatively divides the safety seatbelt into two segments, a lap segment and a chest and shoulder segment, and wherein the buckle of the conventional seatbelt restraint system is located close to the vehicle's back seat near the backrest of the back seat, and wherein the latch plate of the conventional seatbelt restraint system can be comfortably connected and released, enabling safe restraining of a child in normal operation and in case of emergency, and enabling easy and safe release of the child from the child restraint system, the article of manufacture comprising:
(a) a child booster safety seat, having an upper surface for the child to sit upon; and
(b) a seatbelt adaptor, said seatbelt adaptor being positioned adjacent to said child booster safety seat, said seatbelt adaptor including;
(i) a central lengthening device, wherein said lengthening device is a rigid device;
(ii) a latch plate for reversible attachment and detachment to said buckle of said conventional seatbelt restraint system, said latch plate disposed at a first end of said central lengthening device; and
(iii) a buckle for reversible attachment and detachment to said latch plate of said conventional seatbelt restraint system, said buckle disposed at a second end of said central lengthening device,
wherein said latch plate of said seatbelt adaptor is configured for reversibly connecting to said buckle of said conventional seatbelt restraint system, and wherein said buckle of said seatbelt adaptor is configured for reversibly connecting to said latch plate of said conventional seatbelt restraint system, and wherein a length of said seatbelt adaptor is suited to improve the latching of said buckles of said vehicle's conventional seatbelt restraint system,
wherein a geometric characteristics of said child booster safety seat, said seatbelt adaptor, said latch of said conventional seatbelt restraint system, and said buckle of said conventional seatbelt restraint system are combined such that when said latch of said conventional seatbelt restraint system is connected to said buckle of said seatbelt adaptor, and said latch of said seatbelt adaptor is connected to said buckle of said conventional seatbelt restraint system, ensures that when a force is activated on said latch of said conventional seatbelt restraint system upwards with regard to the vehicle, the location of said slot of said latch plate of said conventional seatbelt restraint system is substantially at the same height above said back seat of said vehicle, as the height of said upper surface of said child booster safety seat, and wherein said characteristics enable fast and easy release of the child from said child restraint system, and ensures that in case of emergency braking, said lap segment of said seatbelt will exert an adducting force having a downward component and a backward component, relative to said vehicle, so as to adduct the child's lap downwards and backwards with regard to said child booster safety seat, and said chest and shoulder segment of said seatbelt will exert a backwards adducting force on a chest of the child.

12. (canceled)

13. (canceled)

14. (canceled)

15. (canceled)

16. The seatbelt adaptor of claim 12, wherein said central lengthening device is a safety belt of a fixed length.

17. The seatbelt adaptor of claim 12, wherein said central lengthening device is a safety belt of adjustable length.

18. The seatbelt adaptor of claim 13, wherein said central lengthening device is a safety belt of adjustable length.

19. The seatbelt adaptor of claim 14, wherein said seatbelt adaptor further comprises:
(iv) a device that prevents children from unfastening said second connector;
Wherein said device that prevents children from unfastening said second connector disposed at said seatbelt adaptor.

20. The article of manufacture of claim 11 wherein said article of manufacture further comprises:
(c) a seat cushion disposed at said child booster safety seat;
wherein the combination of the geometrical qualities of said child booster safety seat, said seatbelt adaptor, and said seat cushion, ensures that in the case of emergency breaking the vehicle's seatbelt will exert adducting forces on the child towards the seat in the necessary directions for the child's safety.

21. The article of manufacture of claim 11, wherein said buckle of said seatbelt adaptor has a conventional seatbelt restraint system buckle structure, that enables the detachment of said buckle of said seatbelt adaptor from said latch plate of said conventional seatbelt restraint system, by the single press of a finger, and wherein said buckle of said seatbelt adaptor includes no permanent bolt coupling.
